(19) United States
(12) Patent Application Publication
(10) Pub. No.: US 2012/0075858 A1
(43) Pub. Date: Mar. 29, 2012

(54) LED BULB

(75) Inventors: MIN-TSUN HSIEH, Hsinchu (TW); WEN-LIANG TSENG, Hsinchu (TW); LUNG-HSIN CHEN, Hsinchu (TW); CHIH-YUNG LIN, Hsinchu (TW); CHING-LIEN YEH, Hsinchu (TW); CHUAN-FU YANG, Hsinchu (TW)

(73) Assignee: ADVANCED OPTOELECTRONIC TECHNOLOGY, INC., Hsinchu Hsien (TW)

(21) Appl. No.: 13/172,728

(22) Filed: Jun. 29, 2011

(30) Foreign Application Priority Data
Sep. 27, 2010 (CN) 201010288650.2

(51) Int. Cl. F21S 4/00; F21V 29/00

(52) U.S. Cl. 362/249.02; 362/373

(57) ABSTRACT

An exemplary LED bulb includes a holder, a housing, a heat spreader, a power module and an LED module. The housing connects to the holder. The heat spreader detachably engages with the housing. The power module detachably engages with the housing and is received in the housing. The LED module is arranged on the heat spreader. The LED module electrically connects to the holder via the power module. The LED module is physically separated from the power module.

### BACKGROUND

1. Technical Field

The present disclosure relates generally to illumination devices, and more particularly to a light emitting diode (LED) bulb.

2. Description of Related Art

The use of LEDs as a source of illumination provides advantages such as resistance to shock and nearly limitless lifetime under specific conditions. Thus, illumination devices utilizing LEDs present a cost-effective yet high quality replacement for incandescent and fluorescent lamps.

A typical LED bulb has one or more LED modules integrally combined with a power module. The LED modules and the power module are received in a housing of the LED bulb. Under a specific condition, the LED modules can have a lifetime over 50,000 hours. However, the lifetime of the power module is much less since the power module is prone to damage under the shock of pulse voltage or other factors. When the power module is replaced with a new one, the LED modules which can still work properly are replaced together with the replacement of the power module. Such a replacement in totality, regardless whether there is an actual damage or not, not only causes a waste of the material such as the LEDs, but also results in potential harm to the environment since it needs more energy to recycle the discarded LED modules.

What is needed therefore is an LED bulb which can overcome the above limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a schematic, cross-sectional view of an LED bulb in accordance with a first embodiment of the present disclosure.

FIG. 2 is a schematic, cross-sectional view of an LED bulb in accordance with a second embodiment of the present disclosure.

FIG. 3 is a schematic, cross-sectional view of an LED bulb in accordance with a third embodiment of the present disclosure.

### DETAILED DESCRIPTION

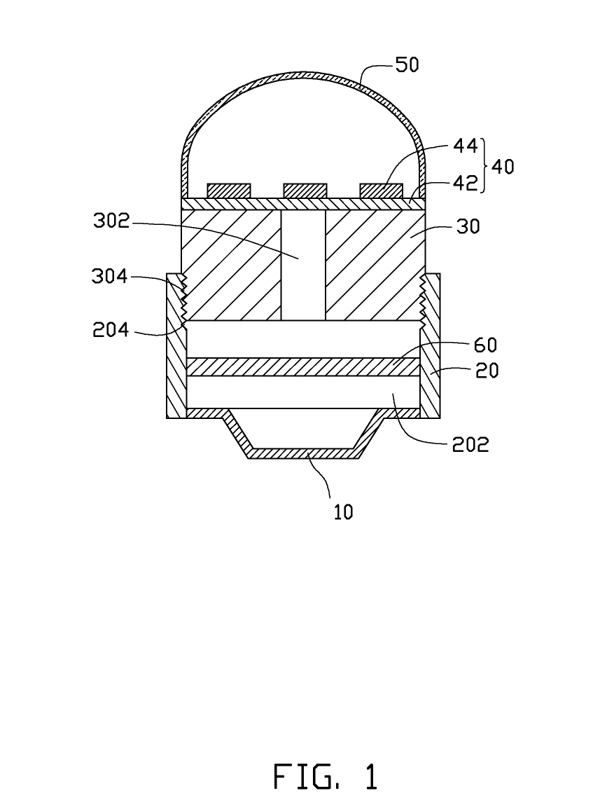

FIG. 1 illustrates an LED bulb in accordance with a first embodiment of the present disclosure. The LED bulb comprises a holder 10, a housing 20 connected to the holder 10, a heat spreader 30 engaged with the housing 20, an LED module 40 arranged on the heat spreader 30, an envelope 50 covering the LED module 40, and a power module 60 received in the housing 20 and electrically connected to the holder 10 and the LED module 40.

The holder 10 can be a standard holder, for example, an Edison holder such as E27, etc., for conveniently connecting to a light bulb socket or other elements which transmit power to the holder 10.

The housing 20 is made of dielectric material such as ceramic. The housing 20 has a bottom end connected to the holder 10. A top end of the housing 20 defines an opening. A receiving space 202 is defined in the housing 20 between the bottom end and the top end of the housing 20 for receiving the power module 60. Inner threads 204 are formed in an inner surface of the top end of the housing 20.

The heat spreader 30 is made of material with good heat conductivity such as metal, ceramic, etc. The heat spreader 30 has a top end for connecting with the LED module 40. A through hole 302 is defined in the heat spreader 30 and extends through the top end and a bottom end of the heat spreader 30. The through hole 302 can provide a passage for extension of wires (not shown) through the heat spreader 30. The wires electrically connect the LED module 40 and the power module 60. Outer threads 304 are formed on an outer surface of the bottom end of the heat spreader 30. The outer threads 304 and the inner threads 204 engage with each other whereby the heat spreader 30 and the housing 20 are threadedly connected together. The heat spreader 30 can be configured with a plurality of fins extending therefrom or other heat dissipating structures formed thereon to enhance the heat dissipating efficiency of the heat spreader 30.

The LED module 40 comprises a board 42 and a plurality of LEDs 44 mounted on the board 42. The board 42 functions as a carrier for carrying the LEDs 44 thereon and an electrical interconnection between the LEDs 44 and the power module 60 and does not function to provide controlling functions such as voltage control for the LEDs 44. The controlling functions reside in the power module 60. The board 42 can be secured on the top end of the heat spreader 30 by any means known in the art. It is noted that, in alternative embodiments, the LEDs 44 can be directly mounted on the heat spreader 30 without the board 42.

The envelope 50 covers the LED module 40 to protect the LEDs 44. The envelope 50 can engage with the heat spreader 30 in accordance with the present embodiment or the housing 20 in alternative embodiments. The envelope 50 is made of transparent or translucent material so that light generated by the LED module 40 can penetrate through the envelope 50 to the ambient environment.

The power module 60 is detachably engaged in the housing 20 and received in the receiving space 202. The engaging mechanism of the power module 60 and the housing 20 can be any of mechanisms known in the art such as screw fastening, snapping etc. The power module 60 electrically connects the LED module 40 and the holder 10 by means known in the art such as pin contact. The power module 60 provides controlling signals such as driving voltage for the LED module 40 during the work of the

LED module 40. The housing 20, the heat spreader 30 and the envelope 50 are electrically insulated from other elements of the LED bulb, for increasing a security of the LED bulb.

The heat spreader 30 is detachably engaged with the housing 20, and the power module 60 is physically separated from the LED module 40 and detachably engaged with the housing 20. Thus, when in a condition that the LED module 40 works properly and the power module 60 is broken down, the power module 60 can be solely detached from the LED bulb for replacement. Compared with conventional LED bulbs, the LED bulb provided in the present disclosure is more economical and environment-friendly. It is also noted that the LED module 40 can be designed to detachably engage with the heat spreader 30, and when the LED module 40 needs to be replaced, only the LED module 40 needs to be removed, the heat spreader 30 and other elements can be retained for continuing use.

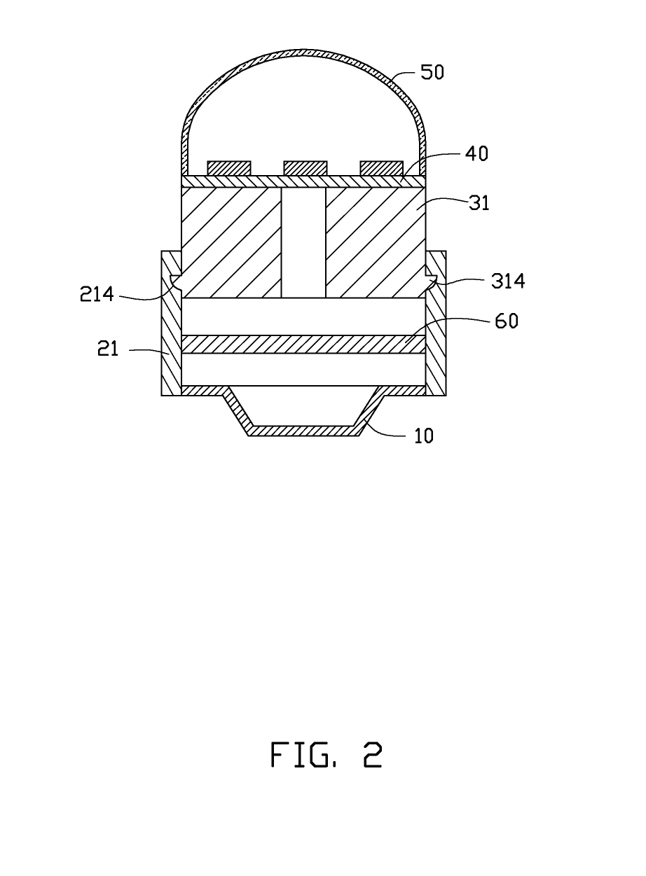

Referring to FIG. 2, an LED bulb in accordance with a second embodiment of the present disclosure is similar to the one in the previous embodiment. The difference is that the housing 21 defines notches 214 in an inner surface thereof, and the heat spreader 31 forms protrusions 314 on an outer surface thereof. The protrusions 314 are received in the notches 214 respectively to accomplish the detachable engagement of the heat spreader 31 and the housing 21.

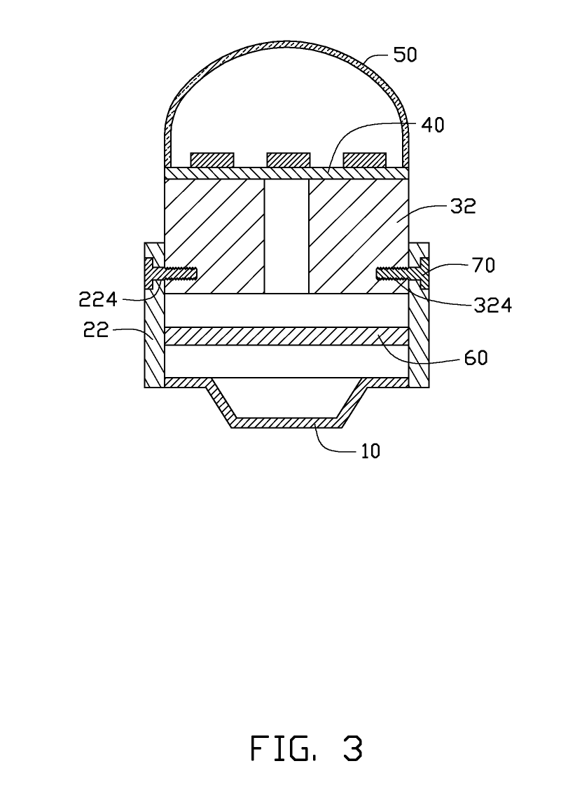

Referring to FIG. 3, an LED bulb in accordance with a third embodiment of the present disclosure is similar to the ones in the previous embodiments. The difference is that through holes 224 are defined in the housing 22 and extend from an outer surface to an inner surface of the housing 22. Threaded holes 324 are defined in the heat spreader 32. Screws 70 insert through the through holes 224 and are engagingly received in the threaded holes 324 to accomplish the detachable engagement of the heat spreader 32 and the housing 22.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A light emitting diode (LED) bulb comprising:
a holder adapted for connecting with a light bulb socket;
a housing having a bottom end connected to the holder;
a heat spreader detachably engaged with a top end of the housing;
a power module detachably engaged with the housing, received in the housing and located below the heat spreader; and
an LED module arranged on a top of the heat spreader, the LED module electrically connecting to the holder via the power module.

2. The LED bulb of claim 1, wherein the heat spreader forms outer threads thereon, the housing forms inner threads therein, and the heat spreader threadedly engages with the housing by the outer threads engaging with the inner threads.

3. The LED bulb of claim 1, wherein the heat spreader forms protrusions thereon, the housing defines notches therein, and the protrusions respectively insert in the notches to accomplish the detachable engagement of the heat spreader and the housing.

4. The LED bulb of claim 1, wherein the heat spreader defines thread holes therein, and the housing defines through holes therein for screws extending through to engage in the thread holes to thereby accomplish the detachable engagement of the heat spreader and the housing.

5. The LED bulb of claim 1 further comprising an envelope covering the LED module.

6. The LED bulb of claim 1, wherein the LED module is detachably engaged with the heat spreader.

7. The LED bulb of claim 1, wherein a bottom end of the heat spreader engages with the top end of the housing and a through hole extends from the bottom end to the top end of the heat spreader adapted for wires extending therethrough to electrically connect the LED module and the power module.

8. An LED bulb comprising:
a holder adapted for engaging with a light bulb socket;
a housing connected to the holder, the housing defining a receiving space therein;
a heat spreader detachably engaged with the housing;
a power module received in the receiving space and detachably engaged with the housing, the power module being positioned beneath the heat spreader; and
a plurality of LEDs detachably mounted on the heat spreader, the LEDs electrically connecting to the holder via the power module.

9. The LED bulb of claim 8, further comprising an envelope covering the LEDs.

10. The LED bulb of claim 8, wherein the heat spreader forms outer threads in a bottom portion thereof, the housing forms inner threads therein, and the outer threads in the bottom portion of the heat spreader threadedly engage with the inner threads in the housing.

11. The LED bulb of claim 8, wherein the heat spreader forms protrusions on a bottom portion thereof, the housing defines notches therein, and the protrusions respectively insert in the notches to accomplish the detachable engagement of the heat spreader and the housing.

12. The LED bulb of claim 8, wherein the heat spreader defines thread holes in a bottom portion thereof, and the housing defines through holes therein for screws insert therethrough to engage in the thread holes to thereby accomplish the detachable engagement of the heat spreader and the housing.

13. An LED bulb comprising:
a holder adapted for connecting the LED bulb to a light bulb socket;
a hollow housing having a first end coupled to the holder and an opposite second end;
a power module detachably engaged in the housing, the power module being electrically connected to the holder; and
an LED module detachably coupled to the second end of the housing, the LED module being electrically connected to and physically separated from the power module.

14. The LED bulb of claim 13, further comprising an envelope covering the LED module.
